(19) United States
(12) Patent Application Publication
(10) Pub. No.: US 2002/0198341 A1
(43) Pub. Date: Dec. 26, 2002

(54) Ethylene resin sealants for laminated films

(76) Inventor: Mamoru Takahashi, Waki-cho (JP)

Correspondence Address: Sherman & Shalloway, 413 North Washington Street, Alexandria, VA, 22314, US

(21) Appl. No.: 10/179,962

(22) Filed: Jun. 26, 2002

Related U.S. Application Data
(63) Continuation of application No. 09/646,524, filed on Sep. 19, 2000.
Application No. 09/646,524 is a 371 of international application No. PCT/JP99/00155, filed on Jan. 19, 1999.

(51) Int. Cl. C08F 4/44

(52) U.S. Cl. 526/160; 526/943; 526/348.2; 526/348.3; 526/348.4; 526/348.5; 525/191; 525/240

(57) ABSTRACT

The present invention provides an ethylene resin sealant for a laminated film, which is excellent in low-temperature heat-sealing properties, hot tack properties, impact resistance, tearability and extrusion properties. This ethylene resin sealant for a laminated film comprises an ethylene/α-olefin copolymer having the following properties: the density is in the range of 0.880 to 0.920 g/cm³; the melt flow rate (MFR) at 190° C. under a load of 2.16 kg is in the range of 0.1 to 5.0 g/10 min; the decane-soluble component fraction (W) at room temperature and the density (d) satisfy the relation W<80×exp(−100(d−0.88))+0.1; the flow index (FI), which is defined as a shear rate at which the shear stress of said copolymer in a molten state at 190° C. reaches 2.4×10⁶ dyne/cm², and MFR satisfy the relation FI>75'MFR; and the melt tension (MT) at 190° C. and MFR satisfy the relation 5.5×MFR^{-0.65}>MT>2.2×MFR^{-0.84}.

### TECHNICAL FIELD

The present invention relates to ethylene resin sealants for laminated films, and more particularly to ethylene resin sealants for laminated films, which are constituents of laminated films produced by dry lamination and are excellent in low-temperature heat-sealing properties, hot tack properties, impact resistance, tearability and extrusion properties.

### BACKGROUND ART

Plastic films have various advantages, but on the other hand, they sometimes have disadvantages in properties such as sealability, moisture resistance, gas barrier properties, heat resistance, low-temperature resistance and printability. In order to diminish these disadvantages, lamination of two or more layers using a single material has been carried out. The laminated films obtained by such lamination are broadly used as films for packaging foods, detergents, chemicals and the like. With increase of property requirements for the packaging films, use of the laminated films has been extended.

One of lamination methods widely adopted in the production of the laminated films is a dry lamination method. The dry lamination method comprises the steps of applying a solvent-soluble adhesive to a film, drying the solvent and bonding the film with another film under pressure to laminate those films together. The dry lamination method is widely used for laminating plastic films such as polyethylene, polypropylene, polyvinyl chloride, polystyrene and polyesters, or laminating these plastic films to aluminum foil, paper or the like.

As a material of a coating film that is a constituent of a laminated film produced by the dry lamination method, a low-density polyethylene resin (what is called “LDPE” or “HPLDPE”) prepared by a high-pressure process has been heretofore employed. When the LDPE is used as sealants, laminated films having good heat-sealing properties at low temperatures can be obtained. Further, because of its good processability, the LDPE has been used in a large amount as sealants.

Although the LDPE has excellent properties for sealants, its heat-sealing strength properties and hot tack properties are poor, so that improvement of LDPE or study of substitutes therefor has been attempted.

As substitutes for LDPE, a high-density polyethylene resin (HDPE), an ethylene/vinyl acetate copolymer resin (EVA) and a linear low-density polyethylene resin (LLDPE) are partly employed.

The high-density polyethylene resin can provide films of good heat-sealing strength properties but has a processing problem that the low-temperature heat-sealing properties of the resulting films are bad.

The ethylene/vinyl acetate copolymer resin can provide films of excellent low-temperature heat-sealing properties, but the resin itself has characteristic odor.

The linear low-density polyethylene resin has a problem that the mechanical properties of the resulting films are poor when the comonomer used as a component of the resin is propylene having 3 carbon atoms or 1-butene having 4 carbon atoms. When an α-olefin having 6 or more carbon atoms is selected as the comonomer, tear strength of films of the linear low-density polyethylene resin becomes higher than needed, although the mechanical strength properties thereof are improved to enhance the impact resistance. Therefore, packaging bags using the linear low-density polyethylene resin as a sealant have poor tearability.

Further, when the linear low-density polyethylene resin is subjected to molding, particularly inflation molding, the load on a motor of an extruder becomes high due to the properties of the resin, and the bubble stability is worse than that in molding of a high-pressure low-density polyethylene resin. In the production of a film having large thickness, cooling of bubble sometimes becomes insufficient to produce an unstable bubble. As a result, film formation becomes difficult, or surface roughening is liable to occur on the resulting film. In order to solve such problems, a molding machine equipped with a die having a large lip width, a screw having a low compression ratio and a motor having a large capacity and capable of effecting powerful cooling is employed to produce a film of the linear low-density polyethylene resin. Therefore, it is difficult to produce a film of the linear low-density polyethylene resin by the use of a molding machine for high-pressure low-density polyethylene in which the lip width is small and the capacity of motor is small.

Accordingly, development of an ethylene resin sealant for a laminated film, which is excellent in low-temperature heat-sealing properties, hot tack properties, impact resistance, tearability and extrusion properties, has been desired.

The present invention is intended to solve such problems associated with the prior art as described above, and it is an object of the invention to provide an ethylene resin sealant for a laminated film, which is excellent in low-temperature heat-sealing properties, hot tack properties, impact resistance, tearability and extrusion properties as well as in moldability.

### DISCLOSURE OF THE INVENTION

The ethylene resin sealant for a laminated film according to the invention comprises an ethylene/α-olefin copolymer (A) which is a copolymer of ethylene and an α-olefin of 6 to 20 carbon atoms and has the following properties:

(i) the density is in the range of 0.880 to 0.920 g/cm³,

(ii) the melt flow rate (MFR (g/10 min)) at 190° C. under a load of 2.16 kg is in the range of 0.1 to 5.0 g/10 min,

(iii) the decane-soluble component fraction (W (% by weight)) at room temperature and the density (d (g/cm³)) satisfy the following relation

W<80×exp(−100(d−0.88))+0.1,

(iv) the flow index (FI (1/sec)), which is defined as a shear rate at which the shear stress of said copolymer in a molten state at 190° C. reaches 2.4×10⁶ dyne/cm², and the melt flow rate (MFR (g/10 min)) satisfy the following relation

FI>75×MFR, and

(v) the melt tension (MT (g)) at 190° C. and the melt flow rate (MFR (g/10 min)) satisfy the following relation

5.5×MFR^{-0.65}>MT>2.2×MFR^{-0.84}.

The ethylene/α-olefin copolymer (A) is preferably an ethylene/α-olefin copolymer obtained by copolymerizing ethylene and an α-olefin of 6 to 20 carbon atoms in the presence of an olefin polymerization catalyst comprising (a) an organoaluminum oxy-compound and (b) at least one compound of a transition metal of Group IV of the periodic table, said compound (b) containing a ligand having cyclopentadienyl skeleton.

The other ethylene resin sealant for a laminated film according to the invention comprises an ethylene/α-olefin copolymer composition which comprises:

(I) 50 to 99 parts by weight of an ethylene/α-olefin random copolymer (A), and

(II) 1 to 50 parts by weight of an ethylene copolymer (B),

wherein the ethylene/α-olefin random copolymer (A) is a copolymer obtained by copolymerizing ethylene and an α-olefin of 6 to 20 carbon atoms in the presence of an olefin polymerization catalyst comprising (a) an organoaluminum oxy-compound and (b) at least one compound of a transition metal of Group IV of the periodic table, said compound (b) containing a ligand having cyclopentadienyl skeleton, and has the following properties:

(i) the density is in the range of 0.880 to 0.918 g/cm³,

(ii) the melt flow rate (MFR (g/10 min)) at 190° C. under a load of 2.16 kg is in the range of 0.03 to 1.0 g/10 min,

(iii) the temperature (Tm (°C)) at the maximum peak position of an endothermic curve, as measured by a differential scanning calorimeter (DSC), and the density (d (g/cm³)) satisfy the following relation

Tm<400d−250,

(iv) the decane-soluble component fraction (W (% by weight)) at room temperature and the density (d (g/cm³)) satisfy the following relation

W<80×exp(−100(d−0.88))+0.1,

(v) the flow index (FI (1/sec)), which is defined as a shear rate at which the shear stress of said copolymer in a molten state at 190° C. reaches 2.4×10⁶ dyne/cm², and the melt flow rate (MFR (g/10 min)) satisfy the following relation

FI>75×MFR, and

(vi) the melt tension (MT (g)) at 190° C. and the melt flow rate (MFR (g/10 min)) satisfy the following relation

5.5×MFR^{-0.65}>MT>2.2×MFR^{-0.84};

and

the ethylene copolymer (B) is a copolymer obtained by copolymerizing ethylene and an α-olefin of 3 to 20 carbon atoms and has the following properties:

(i) the density is in the range of 0.890 to 0.935 g/cm³, and

(ii) the melt flow rate (MFR (g/10 min)) at 190° C. under a load of 2.16 kg is in the range of 0.1 to 100 g/min.

The ethylene resin sealant for a laminated film according to the invention is preferably a film produced by air-cooling inflation molding and having the following properties:

(i) the dart impact strength is not less than 100 kg/cm, and

(ii) the complete sealing temperature is not higher than 130° C.

### BEST MODE FOR CARRYING OUT THE INVENTION

The ethylene resin sealant for a laminated film according to the invention is described in detail hereinafter.

First, the ethylene/α-olefin copolymer (A) for use in the ethylene resin sealant for a laminated film according to the invention is described.

### Ethylene/α-Olefin Copolymer (A)

The ethylene/α-olefin copolymer (A) for use in the invention is a copolymer of ethylene and an α-olefin of 6 to 20 carbon atoms. Examples of the α-olefins of 6 to 20 carbon atoms include 1-hexene, 4-methyl-1-pentene, 1-octene, 1-decene, 1-dodecene, 1-tetradecene, 1-hexadecene, 1-octadecene and 1-eicosene.

In the copolymer, the content of the α-olefin is in the range of 2 to 20% by mol, preferably 3 to 15% by mol.

The ethylene/α-olefin copolymer (A) has a density of 0.880 to 0.920 g/cm³, preferably 0.885 to 0.915 g/cm³.

The ethylene/α-olefin copolymer (A) has a melt flow rate (MFR (g/10 min), as measured at 190° C. under a load of 2.16 kg, of 0.1 to 5.0 g/10 min, preferably 0.3 to 3.0 g/10 min.

The ethylene/α-olefin copolymer (A) has the following relation between the decane-soluble component fraction (W (% by weight) at room temperature and the density (d (g/cm³)):

W<80×exp(−100(d−0.88))+0.1,

preferably W<60×exp(−100(d−0.88))+0.1.

The ethylene/α-olefin copolymer (A) has the following relation between the flow index (FI (1/sec)), which is defined as a shear rate at which the shear stress of said copolymer in a molten state at 190° C. reaches 2.4×10⁶ dyne/cm², and the melt flow rate (MFR (g/10 min)):

FI>75×MFR,

preferably FI>80 ×MFR.

The ethylene/α-olefin copolymer (A) has the following relation between the melt tension (MT (g)) at 190° C. and the melt flow rate (MFR (g/10 min)):

5.5×MFR^{-0.65}>MT>2.2×MFR^{-0.84,}

preferably 5.0×MFR^{-0.65}>MT>2.5×MFR^{-0.84.}

The ethylene/α-olefin copolymer (A) is favorable as a sealant for a laminated film.

The ethylene/α-olefin copolymer (A) can be prepared by, for example, copolymerizing ethylene and an α-olefin of 3 to 20 carbon atoms in the presence of an olefin polymerization catalyst formed from:

(a) a compound of a transition metal of Group IV of the periodic table, which contains a ligand having cyclopentadienyl skeleton,

(b) an organoaluminum oxy-compound,

(c) a carrier,

and optionally

(d) an organoaluminum compound,

in such a manner that the resulting polymer has a density of 0.880 to 0.920 g/cm³.

The olefin polymerization catalyst and the catalyst components are described below.

### (a) Transition Metal Compound

The compound (a) of a transition metal of Group IV of the periodic table, which contains a ligand having cyclopentadienyl skeleton, is specifically a transition metal compound represented by the following formula (I):

ML¹x (I)

wherein M is a transition metal selected from Group IV of the periodic table; L¹ is a ligand coordinated to the transition metal atom, at least two ligands L¹ are each a substituted cyclopentadienyl group having 2 to 5 substituents selected from methyl and ethyl, and the ligand L¹ other than the substituted cyclopentadienyl group is a hydrocarbon group of 1 to 12 carbon atoms, an alkoxy group, an aryloxy group, a halogen atom, a trialkylsilyl group or a hydrogen atom; and x is a valence of the transition metal atom M.

In the formula (I), M is a transition metal atom selected from Group IV of the periodic table, specifically zirconium, titanium or hafnium, preferably zirconium.

L¹ is a ligand coordinated to the transition metal atom M, and at least two ligands L¹ are each a substituted cyclopentadienyl group having 2 to 5 substituents selected from methyl and ethyl. The ligands may be the same or different. The substituted cyclopentadienyl group is a substituted cyclopentadienyl group having two or more substituents, preferably a cyclopentadienyl group having 2 to 3 substituents, more preferably a di-substituted cyclopentadienyl group, particularly preferably a 1,3-substituted cyclopentadienyl group. The substituents may be the same or different.

In the formula (I), the ligand L¹ other than the substituted cyclopentadienyl group coordinated to the transition metal atom M is a hydrocarbon group of 1 to 12 carbon atoms, an alkoxy group, an aryloxy group, a halogen atom, a trialkylsilyl group or a hydrogen atom.

Examples of the transition metal compounds represented by the formula (I) include:

bis(cyclopentadienyl)zirconium dichloride,

bis(methylcyclopentadienyl)zirconium dichloride,

bis(ethylcyclopentadienyl)zirconium dichloride,

bis(n-propylcyclopentadienyl)zirconium dichloride,

bis(n-butylcyclopentadienyl)zirconium dichloride,

bis(n-hexylcyclopentadienyl)zirconium dichloride,

bis(methyl-n-propylcyclopentadienyl)zirconium dichloride,

bis(methyl-n-butylcyclopentadienyl)zirconium dichloride,

bis(dimethyl-n-butylcyclopentadienyl)zirconium dichloride,

bis(n-butylcyclopentadienyl)zirconium dibromide,

bis(n-butylcyclopentadienyl)zirconium methoxychloride,

bis(n-butylcyclopentadienyl)zirconium ethoxychloride,

bis(n-butylcyclopentadienyl)zirconium butoxychloride,

bis(n-butylcyclopentadienyl)zirconium ethoxide,

bis(n-butylcyclopentadienyl)zirconium methylchloride,

bis(n-butylcyclopentadienyl)zirconium dimethyl,

bis(n-butylcyclopentadienyl)zirconium benzylchloride,

bis(n-butylcyclopentadienyl)zirconium dibenzyl,

bis(n-butylcyclopentadienyl)zirconium phenylchloride,

bis(n-butylcyclopentadienyl)zirconium hydride chloride,

bis(dimethylcyclopentadienyl)zirconium dichloride,

bis(diethylcyclopentadienyl)zirconium dichloride,

bis(methylethylcyclopentadienyl)zirconium dichloride,

bis(dimethylethylcyclopentadienyl)zirconium dichloride,

bis(dimethylcyclopentadienyl)zirconium dibromide,

bis(dimethylcyclopentadienyl)zirconium methoxychloride,

bis(dimethylcyclopentadienyl)zirconium ethoxychloride,

bis(dimethylcyclopentadienyl)zirconium butoxychloride,

bis(dimethylcyclopentadienyl)zirconium diethoxide,

bis(dimethylcyclopentadienyl)zirconium methylchloride,

bis(dimethylcyclopentadienyl)zirconium dimethyl,

bis(dimethylcyclopentadienyl)zirconium benzylchloride,

bis(dimethylcyclopentadienyl)zirconium dibenzyl, bis(dimethylcyclopentadienyl)zirconium

phenylchloride, and

bis(dimethylcyclopentadienyl)zirconium hydride chloride.

In the above examples, the di-substituted cyclopentadienyl rings include 1,2- and 1,3-substituted cyclopentadienyl rings, and the tri-substituted cyclopentadienyl rings include 1,2,3- and 1,2,4-substituted cyclopentadienyl rings. In the present invention, transition metal compounds wherein a zirconium metal is replaced with a titanium metal or a hafnium metal in the above-mentioned zirconium compounds are also employable.

Of these transition metal compounds represented by the formula (I), particularly preferable are:

bis(n-propylcyclopentadienyl)zirconium dichloride,

bis(n-butylcyclopentadienyl)zirconium dichloride,

bis(1-methyl-3-n-propylcyclopentadienyl)zirconium dichloride,

bis(1-methyl-3-n-butylcyclopentadienyl)zirconium dichloride,

bis(1,3-dimethylcyclopentadienyl)zirconium dichloride,

bis(1,3-diethylcyclopentadienyl)zirconium dichloride, and

bis(1-methyl-3-ethylcyclopentadienyl)zirconium dichloride.

Two or more transition metal compounds selected from the transition metal compounds represented by the formula (I) can be used in combination.

As the transition metal compound for use in the invention, a mixture of the transition metal compound represented by the formula (I) and a transition metal compound represented by the following formula (II) may be employed.

MKL²x−2 (II)

wherein M is a transition metal atom selected from Group IVB of the periodic table; K and L² are each a ligand coordinated to the transition metal atom; the ligand K is a bidentate ligand wherein the same or different groups selected from an indenyl group, a substituted indenyl group and their partially hydrogenated products are linked through a lower alkylene group; the ligand L² is a hydrocarbon group of 1 to 12 carbon atoms, an alkoxy group, an aryloxy group, a halogen atom, a trialkylsilyl group or a hydrogen atom; and x is a valence of the transition metal atom M.

Examples of the transition metal compounds represented by the formula (II) include:

ethylenebis(indenyl)zirconium dichloride,

ethylenebis(4-methyl-1-indenyl)zirconium dichloride, and

ethylenebis(4,5,6,7-tetrahydro-1-indenyl)zirconium dichloride.

It is desirable that at least one compound selected from the transition metal compounds (a-1) represented by the formula (I) and at least one compound selected from the transition metal compounds (a-2) represented by the formula (II) are used in such amounts that the (a-1)/(a-2) ratio by mol becomes 99/1 to 50/50, preferably 97/3 to 70/30, more preferably 95/5 to 75/25, most preferably 90/10 to 80/20.

### (b) Organoaluminum Oxy-Compound

The organoaluminum oxy-compound (b) (sometimes referred to as a “component (b)” hereinafter) for use in the invention may be benzene-soluble aluminoxane hitherto known or such a benzene-insoluble organoaluminum oxy-compound as disclosed in Japanese Patent Laid-Open Publication No. 276807/1990.

The aluminoxane can be prepared by, for example, the following processes.

(1) An organoaluminum compound such as trialkylaluminum is added to a hydrocarbon medium suspension of a compound containing adsorption water or a salt containing water of crystallization, e.g., magnesium chloride hydrate, copper sulfate hydrate, aluminum sulfate hydrate, nickel sulfate hydrate or cerous chloride hydrate, to react with them, and the aluminoxane is recovered as a hydrocarbon solution.

(2) Water, ice or water vapor is allowed to directly act on an organoaluminum compound such as trialkylaluminum in a medium such as benzene, toluene, ethyl ether or tetrahydrofuran, and the aluminoxane is recovered as a hydrocarbon solution.

(3) An organotin oxide such as dimethyltin oxide or dibutyltin oxide is allowed to react with an organoaluminum compound such as trialkylaluminum in a medium such as decane, benzene or toluene.

The aluminoxane may contain a small amount of an organometallic component. It is possible that the solvent or the unreacted organoaluminum compound is distilled off from the recovered solution of aluminoxane and the remainder is redissolved in a solvent.

Examples of the organoaluminum compounds used for preparing the aluminoxane include:

trialkylaluminums, such as trimethylaluminum, triethylaluminum, tripropylaluminum, triisopropylaluminum, tri-n-butylaluminum, triisobutylaluminum, tri-sec-butylaluminum, tri-tert-butylaluminum, tripentylaluminum, trihexylaluminum, trioctylaluminum and tridecylaluminum;

tricycloalkylaluminums, such as tricyclohexylaluminum and tricyclooctylaluminum;

dialkylaluminum halides, such as dimethylaluminum chloride, diethylaluminum chloride, diethylaluminum bromide and diisobutylaluminum chloride;

dialkylaluminum hydrides, such as diethylaluminum hydride and diisobutylaluminum hydride;

dialkylaluminum alkoxides, such as dimethylaluminum methoxide and diethylaluminum ethoxide; and

dialkylaluminum aryloxides, such as diethylaluminum phenoxide.

Of these, trialkylaluminums and trialkylaluminums are particularly preferable.

Also employable as the organoaluminum compound is isoprenylaluminum represented by the following formula:

(i−C₄H₉)ₓAl_{y}(C₅H₁₀)_{z}

wherein x, y, z are each a positive number, and z≧2x.

The organoaluminum compounds mentioned above are used singly or in combination.

Examples of the solvents used for preparing the aluminoxane include aromatic hydrocarbons, such as benzene, toluene, xylene, cumene and cymene; aliphatic hydrocarbons, such as pentane, hexane, heptane, octane, decane, dodecane, hexadecane and octadecane; alicyclic hydrocarbons, such as cyclopentane, cyclohexane, cyclooctane and methylcyclopentane; petroleum fractions, such as gasoline, kerosine and gas oil; and halogenated products of these aromatic, aliphatic and alicyclic hydrocarbons, particularly chlorinated or brominated products thereof. Also employable are ethers such as ethyl ether and tetrahydrofuran. Of the solvents, aromatic hydrocarbons are particularly preferable.

The benzene-insoluble organoaluminum oxy-compound contains not more than 10% (in terms of Al atom), preferably not more than 5%, particularly preferably not more than 2%, of an Al component that is soluble in benzene at 60° C., and is insoluble or sparingly soluble in benzene.

The solubility of the organoaluminum oxy-compound in benzene can be determined in the following manner. The organoaluminum oxy-compound in an amount corresponding to 100 mg·atom of Al is suspended in 100 ml of benzene, and they are mixed at 60° C. for 6 hours with stirring. Then, the mixture is subjected to hot filtration at 60° C. using a jacketed G-5 glass filter, and the solid separated on the filter is washed four times with 50 ml of benzene at 60° C. to obtain filtrates. The amount (x mmol) of Al atom present in all of the filtrates is measured to determine the solubility (x %).

### (c) Carrier

The carrier (c) for use in the invention is an inorganic or organic compound of granular or particulate solid having a particle diameter of 10 to 300 μm, preferably 20 to 200 μm. The inorganic carrier is preferably a porous oxide, and examples thereof include SiO₂, Al₂O₃, MgO, ZrO₂, TiO₂, B₂O₃, CaO, ZnO, BaO, ThO₂, and mixtures thereof such as SiO₂—MgO, SiO₂—Al₂O₃, SiO₂—TiO₂, SiO₂—V₂O₅, SiO₂—Cr₂O₃ and SiO₂—TiO₂—MgO. Of these, preferable are oxides containing at least one component selected from the group consisting of SiO₂ and Al₂O₃ as their major component.

The inorganic oxides may contain small amounts of carbonate, sulfate, nitrate and oxide components, such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O and Li₂O.

Although the carriers (c) differ in the properties depending upon the type and the preparation process, the carrier preferably used in the invention desirably has a specific surface area of 50 to 1000 m²/g, preferably 100 to 700 m²/g, and a pore volume of 0.3 to 2.5 cm³/g. If desired, the carrier is calcined at a temperature of 100 to 1000° C., preferably 150 to 700° C., prior to use.

Also employable as the carrier in the invention is an organic compound of granular or particulate solid having a particle diameter of 10 to 300 μm. Examples of such organic compounds include (co)polymers produced using an α-olefin of 2 to 14 carbon atoms such as ethylene, propylene, 1-butene or 4-methyl-1-pentene as a main component, and (co)polymers produced using vinylcyclohexane or styrene as a main component.

The olefin polymerization catalyst used for preparing the ethylene/α-olefin copolymer (A) for use in the invention is formed from the component (a), the component (b) and the carrier (c), but an organoaluminum compound (d) may also be used, if necessary.

### (d) Organoaluminum Compound

The organoaluminum compound (d) (sometimes referred to as a “component (d)” hereinafter) optionally used in the invention is, for example, an organoaluminum compound represented by the following formula (III):

R¹ₙAlX₃₋ₙ (III)

wherein R¹ is a hydrocarbon group of 1 to 12 carbon atoms, X is a halogen atom or a hydrogen atom, and n is 1 to 3.

In the formula (III), R¹ is a hydrocarbon group of 1 to 12 carbon atoms, e.g., an alkyl group, a cycloalkyl group or an aryl group. Examples of such groups include methyl, ethyl, n-propyl, isopropyl, isobutyl, pentyl, hexyl, octyl, cyclopentyl, cyclohexyl, phenyl and tolyl.

Examples of such organoaluminum compounds include:

trialkylaluminums, such as trimethylaluminum, triethylaluminum, triisopropylaluminum, triisobutylaluminum, trioctylaluminum and tri-2-ethylhexylaluminum;

alkenylaluminums, such as isoprenylaluminum;

dialkylaluminum halides, such as dimethylaluminum chloride, diethylaluminum chloride, diisopropylaluminum chloride, diisobutylaluminum chloride and dimethylaluminum bromide;

alkylaluminum sesquihalides, such as methylaluminum sesquichloride, ethylaluminum sesquichloride, isopropylaluminum sesquichloride, butylaluminum sesquichloride and ethylaluminum sesquibromide;

alkylaluminum dihalides, such as methylaluminum dichloride, ethylaluminum dichloride, isopropylaluminum dichloride and ethylaluminum dibromide; and

alkylaluminum hydrides, such as diethylaluminum hydride and diisobutylaluminum hydride.

Also employable as the organoaluminum compound (d) is a compound represented by the following formula (IV):

R¹ₙAlY₃₋ₙ (IV)

wherein R¹ is the same hydrocarbon as indicated by R¹ in the formula (III); Y is —OR² group, —OSiR³₃ group, —OAlR⁴₂ group, —NR⁵₂ group, —SiR⁶₃ group or —N(R⁷)AlR⁸₂ group; n is 1 to 2; R², R³, R⁴ and R⁸ are each methyl, ethyl, isopropyl, isobutyl, cyclohexyl, phenyl or the like; R⁵ is hydrogen, methyl, ethyl, isopropyl, phenyl, trimethylsilyl or the like; and R⁶ and R⁷ are each methyl, ethyl or the like.

Examples of such organoaluminum compounds include:

(1) compounds represented by R¹ₙAl(OR²)₃₋ₙ, such as dimethylaluminum methoxide, diethylaluminum ethoxide and diisobutylaluminum methoxide;

(2) compounds represented by R¹ₙAl(OSiR³₃)₃₋ₙ, such as Et₂Al(OSiMe₃), (iso-Bu)₂Al(OSiMe₃) and (iso-Bu)₂Al(OSiEt3);

(3) compounds represented by R¹ₙAl(OAlR⁴₂)₃₋ₙ, such as Et₂AlOAlEt₂ and (iso-Bu)₂AlOAl(iso-Bu)₂;

(4) compounds represented by R¹ₙAl(NR⁵₂)₃₋ₙ, such as Me₂AlNEt₂, Et₂AlNHMe, Me₂AlNHEt, Et₂AlN(SiMe₃)₂ and (iso-Bu)₂AlN(SiMe₃)_{2;}

(5) compounds represented by R¹ₙAl(SiR⁶₃)₃₋ₙ, such as (iso-Bu)₂AlSiMe₃; and

(6) compounds represented by R¹ₙAl(N(R⁷)AlR⁸₂)₃₋ₙ, such as Et₂AlN(Me)AlEt₂ and (iso-Bu)₂AlN(Et)Al(iso-Bu)₂.

Of the organoaluminum compounds represented by the formulas (III) and (IV), preferable are compounds represented by the formulas R¹₃Al, R¹ₙAl(OR²)₃₋ₙ and R¹ₙAl(OAlR⁴₂)₃₋ₙ, and particularly preferable are compounds of said formulas wherein R¹ is an isoalkyl group and n is 2.

### Process for Preparing Ethylene/α-Olefin Copolymer (A)

In the preparation of the ethylene/α-olefin copolymer (A) for use in the invention, a catalyst prepared by contacting the component (a), the component (b), the carrier (c), and if necessary, the component (d) with one another is employed. Although the components may be contacted in any order, it is preferable to contact the carrier (c) with the component (b), then with the component (a), and then if necessary, with the component (d).

The contact of the components can be carried out in an inert hydrocarbon solvent. Examples of the inert hydrocarbon media used for preparing the catalyst include aliphatic hydrocarbons, such as propane, butane, pentane, hexane, heptane, octane, decane, dodecane and kerosine; alicyclic hydrocarbons, such as cyclopentane, cyclohexane and methylcyclopentane; aromatic hydrocarbons, such as benzene, toluene and xylene; halogenated hydrocarbons, such as ethylene chloride, chlorobenzene and dichloromethane; and mixtures of these hydrocarbons.

In the contact of the component (a), the component (b), the carrier (c) and the component (d) optionally used, the component (a) is used in an amount of usually 5×10⁻⁶ to 5×10⁻⁴ mol, preferably 10⁻⁵ to 2×10 ⁻⁴ mol, based on 1 g of the carrier (c), and the concentration of the component (a) is in the range of about 10⁻⁴ to 2×10⁻² mol/liter, preferably 2×10⁻⁴ to 10⁻² mol/liter. The atomic ratio (Al/transition metal) of aluminum in the component (b) to the transition metal in the component (a) is in the range of usually 10 to 500, preferably 20 to 200. The atomic ratio ((Al-d)/(Al-b)) of an aluminum atom (Al-d) in the component (d) optionally used to an aluminum atom (Al-b) in the component (b) is in the range of usually 0.02 to 3, preferably 0.05 to 1.5. In the contact of the component (a), the component (b), the carrier (c) and the component (d) optionally used, the mixing temperature is in the range of usually −50 to 150° C., preferably −20 to 120° C., and the contact time is in the range of usually 1 minute to 50 hours, preferably 10 minutes to 25 hours.

In the olefin polymerization catalyst obtained as above, the transition metal atom derived from the component (a) is desirably supported in an amount of 5×10⁻⁶ to 5×10⁻⁴ g·atom, preferably 10⁻⁵ to 2×10⁻⁴ g·atom, based on 1 g of the carrier (c), and the aluminum atom derived from the component (b) and the component (d) is desirably supported in an amount of 10⁻³ to 5×10⁻² g·atom, preferably 2×10⁻³ to 2×10⁻² g·atom, based on 1 g of the carrier (c).

The catalyst used for preparing the ethylene copolymer may be a prepolymerized catalyst obtained by prepolymerizing an olefin in the presence of the component (a), the component (b), the carrier (c) and the component (d) optionally used. The prepolymerization can be carried out by introducing an olefin into an inert hydrocarbon solvent in the presence of the component (a), the component (b), the carrier (c) and the component (d) optionally used.

Examples of the olefins used in the prepolymerization include ethylene and α-olefins of 3 to 20 carbon atoms, such as propylene, 1-butene, 1-pentene, 4-methyl-1-pentene, 1-hexene, 1-octene, 1-decene, 1dodecene and 1-tetradecene. Of these, particularly preferable is ethylene or a combination of ethylene and the same α-olefin as used in the polymerization.

In the prepolymerization, the component (a) is used in an amount of usually 10⁻⁶ to 2×10⁻² mol/liter, preferably 5×10⁻⁵ to 10⁻² mol/liter, and the component (a) is used in an amount of 5×10⁻⁶ to 5×10⁻⁴ mol, preferably 10⁻⁵ to 2×10⁻⁴ mol, based on 1 g of the carrier (c). The atomic ratio (Al/transition metal) of aluminum in the component (b) to the transition metal in the component (a) is in the range of usually 10 to 500, preferably 20 to 200. The atomic ratio ((Al-d)/(Al-b)) of an aluminum atom (Al-d) in the component (d) optionally used to an aluminum atom (Al-b) in the component (b) is in the range of usually 0.02 to 3, preferably 0.05 to 1.5. The prepolymerization temperature is in the range of −20 to 80° C., preferably 0 to 60° C., and the prepolymerization time is in the range of 0.5 to 100 hours, preferably about 1 to 50 hours.

The prepolymerized catalyst is prepared by, for example, the following process. The carrier (c) is suspended in an inert hydrocarbon to give a suspension. To the suspension, the organoaluminum oxy-compound (component (b)) is added, and they are reacted for a given period of time. Then, the supernatant liquid is removed, and the resulting solid component is resuspended in an inert hydrocarbon. To the system, the transition metal compound (component (a)) is added, and they are reacted for a given period of time. Then, the supernatant liquid is removed to obtain a solid catalyst component. Subsequently, to an inert hydrocarbon containing the organoaluminum compound (component (d)), the above-obtained solid catalyst component is added and an olefin is further introduced, whereby a prepolymerized catalyst is obtained.

It is desirable that the amount of an olefin polymer produced in the prepolymerization is in the range of 0.1 to 500 g, preferably 0.2 to 300 g, more preferably 0.5 to 200 g, based on 1 g of the carrier (c). In the prepolymerized catalyst, the component (a) is desirably supported in an amount of about 5×10⁻⁶ to 5×10⁻⁴ g·atom, preferably 10⁻⁵ to 2×10⁻⁴ g·atom, in terms of the transition metal atom, based on 1 g of the carrier (c), and the aluminum atom (Al) derived from the component (b) and the component (d) is desirably supported in such an amount that the molar ratio (Al/M) of the aluminum atom (Al) to the transition metal atom (M) derived from the component (a) becomes 5 to 200, preferably 10 to 150.

The prepolymerization can be carried out by any of batchwise and continuous processes, and can be carried out under reduced pressure, at atmospheric pressure or under pressure. In the prepolymerization, it is desirable that hydrogen is allowed to be present in the system to produce a prepolymer having an intrinsic viscosity (η), as measured in decalin at 135° C., of 0.2 to 7 dl/g, preferably 0.5 to 5 dl/g.

The ethylene/α-olefin copolymer (A) for use in the invention is obtained by copolymerizing ethylene and an α-olefin of 6 to 20 carbon atoms, such as 1-hexene, 4-methyl-1-pentene, 1-octene, 1-decene, 1-dodecene, 1-tetradecene, 1-hexadecene, 1-octadecene or 1-eicosene, in the presence of the olefin polymerization catalyst or the prepolymerized catalyst described above.

In the present invention, copolymerization of ethylene and an α-olefin is carried out in a gas phase or a liquid phase of slurry. In the slurry polymerization, an inert hydrocarbon may be used as the solvent, or the olefin itself can be used as the solvent.

Examples of the inert hydrocarbon solvents used in the slurry polymerization include aliphatic hydrocarbons, such as butane, isobutane, pentane, hexane, octane, decane, dodecane, hexadecane and octadecane; alicyclic hydrocarbons, such as cyclopentane, methylcyclopentane, cyclohexane and cyclooctane; aromatic hydrocarbons, such as benzene, toluene and xylene; and petroleum fractions, such as gasoline, kerosine and gas oil. Of the inert hydrocarbon media, preferable are aliphatic hydrocarbons, alicyclic hydrocarbons and petroleum fractions.

When the copolymerization is carried out as slurry polymerization or gas phase polymerization, the olefin polymerization catalyst or the prepolymerized catalyst is desirably used in an amount of usually 10⁻⁸ to 10⁻³ g·atom/liter, preferably 10⁻⁷ to 10⁻⁴ g·atom/liter, in terms of a concentration of the transition metal atom in the polymerization reaction system.

In the polymerization, an organoaluminum oxy-compound similar to the component (b) and/or the organoaluminum compound (d) may be added. In this case, the atomic ratio (Al/M) of an aluminum atom (Al) derived from the organoaluminum oxy-compound and the organoaluminum compound to the transition metal atom (M) derived from the transition metal compound (a) is in the range of 5 to 300, preferably 10 to 200, more preferably 15 to 150.

When the slurry polymerization is conducted, the polymerization temperature is in the range of usually −50 to 100° C., preferably 0 to 90° C. When the gas phase polymerization is conducted, the polymerization temperature is in the range of usually 0 to 120° C., preferably 20 to 100° C.

The polymerization pressure is in the range of usually atmospheric pressure to 100 kg/cm², preferably 2 to 50 kg/cm². The polymerization can be carried out by any of batchwise, semi-continuous and continuous processes.

It is possible to conduct polymerization in two or more stages under different reaction conditions.

To the ethylene/α-olefin copolymer (A) for use in the invention, additives, such as weathering stabilizer, heat stabilizer, antistatic agent, anti-slip agent, anti-blocking agent, anti-fogging agent, lubricant, pigment, dye, nucleating agent, plasticizer, anti-aging agent, hydrochloric acid absorbent and antioxidant, may be optionally added in amounts not detrimental to the object of the present invention. Further, other polymer compounds can be blended in small amounts without departing from the spirit of the present invention.

### Ethylene/α-Olefin Copolymer Composition

The ethylene/α-olefin copolymer composition for use in the invention comprises the ethylene/α-olefin copolymer (A) mentioned above and an ethylene copolymer (B) obtained by copolymerizing ethylene and an α-olefin of 3 to 20 carbon atoms.

In the ethylene/α-olefin copolymer composition, the ethylene/α-olefin copolymer (A) is desirably contained in an amount of 50 to 99 parts by weight, preferably 50 to 90 parts by weight, more preferably 55 to 85 parts by weight, and the ethylene copolymer (B) is desirably contained in an amount of 1 to 50 parts by weight, preferably 10 to 50 parts by weight, more preferably 15 to 45 parts by weight.

The ethylene/α-olefin copolymer (A) is described below.

The ethylene/α-olefin copolymer (A) has a density of 0.880 to 0.918 g/cm³, preferably 0.885 to 0.918 g/cm³.

The ethylene/α-olefin copolymer (A) has a melt flow rate (MFR (g/10 min), as measured at 190° C. under a load of 2.16 kg, of 0.03 to 1.0 g/10 min, preferably 0.05 to 0.8 g/10 min.

The ethylene/α-olefin copolymer (A) has the following relation between the temperature (Tm (° C.)) at the maximum peak position of an endothermic curve, as measured by a differential scanning calorimeter (DSC), and the density (d (g/cm³)):

Tm<400d−250,

preferably Tm<450d−297.

The ethylene/α-olefin copolymer (A) has the following relation between the decane-soluble component fraction (W (% by weight) at room temperature and the density (d (g/cm³)):

W<80×exp(−100(d−0.88))+0.1,

preferably W<60×exp(−100(d−0.88))+0.1.

The ethylene/α-olefin copolymer (A) has the following relation between the flow index (FI (1/sec)), which is defined as a shear rate at which the shear stress of said copolymer in a molten state at 190° C. reaches 2.4×10⁶ dyne/cm², and the melt flow rate (MFR (g/10 min)):

FI>75×MFR,

preferably FI>80×MFR.

The ethylene/α-olefin copolymer (A) has the following relation between the melt tension (MT (g)) at 190° C. and the melt flow rate (MFR (g/10 min)):

5.5×MFR^{-0.65}>MT>2.2×MFR^{-0.84},

preferably 5.5×MFR^{-0.65}>MT>2.5×MFR^{--0.84}.

Next, the ethylene copolymer (B) is described.

The ethylene copolymer (B) has a density of 0.890 to 0.935 g/cm³, preferably 0.895 to 0.930 g/cm³.

The ethylene copolymer (B) has a melt flow rate (MFR (g/10 min)), as measured at 190° C. under a load of 2.16 kg, of 0.1 to 100 g/10 min, preferably 0.5 to 80 g/10 min.

For preparing the ethylene copolymer (B), any of known polymerization processes is employable, as far as the resulting copolymer has the above properties. The ethylene copolymer (B) is preferably one prepared by the use of a titanium catalyst component or a metallocene catalyst component.

The ethylene/α-olefin copolymer composition for use in the invention can be prepared by known processes, for example, the following processes.

(1) The ethylene/α-olefin copolymer (A), the ethylene copolymer (B) and other components optionally used are mechanically blended using an extruder, a kneader or the like.

(2) The ethylene/α-olefin copolymer (A), the ethylene copolymer (B) and other components optionally used are dissolved in an appropriate good solvent (e.g., hydrocarbon solvent, such as hexane, heptane, decane, cyclohexane, benzene, toluene or xylene), and the solvent is then removed.

(3) The ethylene/α-olefin copolymer (A), the ethylene copolymer (B) and other components optionally used are each dissolved in an appropriate good solvent to prepare solutions, then the solutions are mixed, and the solvents are removed.

(4) The processes (1) to (3) are carried out in combination.

Other than the above-mentioned processes, the following processes are employable to prepare the ethylene/α-olefin copolymer composition.

Using one polymerization reactor, the polymerization is conducted in two or more stages under different reaction conditions to prepare the ethylene/α-olefin copolymer (A) and the ethylene copolymer (B). More specifically, in a two-stage polymerization process, the ethylene/α-olefin copolymer (A) is produced in the former stage and the ethylene copolymer (B) is produced in the latter stage, or the ethylene copolymer (B) is produced in the former stage and the ethylene/α-olefin copolymer (A) is produced in the latter stage, whereby the composition can be prepared.

Otherwise, using plural polymerization reactors, the ethylene/α-olefin copolymer (A) is produced in one reactor and the ethylene copolymer (B) is then produced in another reactor in the presence of the ethylene/α-olefin copolymer (A), or the ethylene copolymer (B) is produced in one reactor and the ethylene/α-olefin copolymer (A) is then produced in another reactor in the presence of the ethylene copolymer (B), whereby the composition can be prepared.

The ethylene/α-olefin copolymer composition is favorable as a sealant for a laminated film.

To the ethylene/α-olefin copolymer composition for use in the invention, additives, such as weathering stabilizer, heat stabilizer, antistatic agent, anti-slip agent, anti-blocking agent, anti-fogging agent, lubricant, pigment, dye, nucleating agent, plasticizer, anti-aging agent, hydrochloric acid absorbent and antioxidant, may be optionally added in amounts not detrimental to the object of the present invention. Further, other polymer compounds can be blended in small amounts without departing from the spirit of the present invention.

### Ethylene Resin Sealant for Laminated Film

The ethylene resin sealant for a laminated film according to the invention can be prepared by air-cooling inflation of the ethylene/α-olefin copolymer or the composition described above.

The ethylene resin sealant for a laminated film according to the invention has a dart impact strength of not less than 100 kg/cm, preferably not less than 150 kg/cm, and the sealant has a complete sealing temperature of not higher than 130° C., preferably 110 to 130° C.

The ethylene resin sealant for a laminated film according to the invention has a blocking strength of usually not more than 1.5 g/cm and a Young's modulus of usually not less than 3500 kg/cm².

The ethylene resin sealant for a laminated film according to the invention has a thickness of 10 to 150 μm, preferably 10 to 60 μm.

When the ethylene resin sealant for a laminated film according to the invention is dry laminated to a substrate, a laminated film can be obtained.

A thin film made of any material capable of forming a film is employable as the substrate. Examples of the thin films include polymer film, polymer sheet, cloth, paper, metal foil and cellophane.

### Effect of the Invention

The ethylene resin sealant for a laminated film according to the invention is excellent in low-temperature heat-sealing properties, hot tack properties, impact resistance, blocking resistance, tearability and extrusion properties.

### EXAMPLE

The present invention is further described with reference to the following examples, but it should be construed that the invention is in no way limited to those examples.

In the examples and the comparative examples, properties of the sealants were measured in the following manner.

(1) Moldability

The bubble stability in the molding process was observed and ranked as follows.

◯: good

X: bad

(2) Young's Modulus

The film was subjected to a tensile test in MD and TD using a tensile tester of constant-crosshead speed type (manufactured by Instron Co.).

Test Conditions

Sample: JIS K 6781

Surrounding temperature: 23° C.

Pulling rate: 500 mm/min

Chart rate: 200 mm/min

Using the chart obtained by the above test, Young's moduli of the film in MD and TD were calculated from the following formula, and an average of the obtained values was taken as a Young's modulus (E) of the film.

E₀=R₀(L₀/A)

wherein E₀ is a Young's modulus in each direction, R₀ is an initial tangent modulus, L₀ is a distance between chucks, and A is a minimum area of the sample just after preparation.

Ro was calculated from the following formula.

R₀=F₁/L₁

wherein F₁ is a load at an arbitrary point on the initial tangent, and L₁ is an elongation corresponding to F₁ on the tangent.

(3) Tear Strength (Indication of Tearability)

A tear test was carried out in accordance with JIS Z 1702 to measure a tear strength of the film in the machine direction.

(4) Dart Impact Strength

The value measured in accordance with the method A of ASTM D 1709 was divided by the thickness of the film, and the obtained value was taken as a dart impact strength.

(5) Complete Sealing Temperature (Indication of Low-Temperature Heat-Sealing Properties)

A peel test was carried out with changing the heat-sealing temperature in accordance with JIS Z 1707. The lowest temperature at which the heat-sealed portion was broken in this test was taken as a complete heat-sealing temperature.

(6) Hot Tack Properties

Two of laminated film specimens (550 mm (length)×20 mm (width)) were each allowed to have a weight of 45 g at the same end through a guide roll and superposed upon each other. Then, the specimens were sealed at a temperature of 100° C., 110° C. or 115° C. under a pressure of 2 kg/cm² for 1 second by means of a seal bar having a width of 5 mm and a length of 300 mm. Thereafter, simultaneously with detaching the seal bar from the specimens, a peel force due to the weight was allowed to act on the sealed portion at an angle of 23° to forcedly peel the sealed portion, and the distance (mm) peeled was measured. The “angle” mentioned above can be controlled by adjusting the position of the guide roll through which the weight is provided. The hot tack properties were evaluated by the distance peeled. The film with a shorter distance peeled has better hot tack properties.

(7) Blocking Strength

The blocking strength was measured in the following manner in accordance with ASTM D 1893-67.

In a constant temperature room at 50° C., two specimens (150 mm (length)×200 mm (width)) were superposed upon each other, and thereto was applied a load of 10 kg/cm², followed by allowing them to stand for 1 day. Then, the load was removed, and the specimens having blocked together were separated from each other in MD at a rate of 200 mm/min using a tensile tester of constant crosshead speed type (manufactured by Instron Co.) equipped with a clamp having a separating bar. The value (g) obtained by subtracting the weight of the film (specimen) from the force required to separate the specimen was divided by the width (cm) of the specimen. The obtained value was taken as a blocking strength (g/cm).

### Preparation Example 1

### Preparation of Catalyst Component

In 121 liters of toluene, 7.9 kg of silica having been dried at 250° C. for 10 hours was suspended, and the suspension was cooled to 0° C. To the suspension, 41 liters of a toluene solution of methylaluminoxane (Al=1.47 mol/l) was dropwise added over a period of 1 hour. During the addition, the temperature of the system was maintained at 0° C. The reaction was successively conducted at 0° C. for 30 minutes, then the temperature of the system was raised up to 95° C. over a period of 1.5 hours, and at that temperature, the reaction was conducted for 4 hours. Thereafter, the temperature of the system was lowered to 60° C., and the supernatant liquid was removed by decantation. The resulting solid component was washed twice with toluene and then resuspended in 125 liters of toluene. To the system, 20 liters of a toluene solution of bis(1,3-dimethylcyclopentadienyl)zirconium dichloride (Zr=28.4 mmol/1) was dropwise added at 30° C. over a period of 30 minutes, and the reaction was further conducted at 30° C. for 2 hours. Then, the supernatant liquid was removed, and the remainder was washed twice with hexane to obtain a solid catalyst containing 4.6 mg of zirconium per gram of the solid catalyst.

### Preparation of Prepolymerized Catalyst

To 160 liters of hexane containing 16 mol of triisobutylaluminum, 4.3 kg of the solid catalyst obtained above was added, and prepolymerization of ethylene was carried out at 35° C. for 3.5 hours to obtain a prepolymerized catalyst wherein an ethylene polymer had been produced by prepolymerization in an amount of 3 g per gram of the solid catalyst. The intrinsic viscosity (η) of the ethylene polymer was 1.27 dl/g.

### Polymerization

In a continuous type fluidized bed gas phase polymerization apparatus, copolymerization of ethylene and 1-hexene was carried out at a polymerization temperature of 80° C. under a total pressure of 20 kg/cm²-G. To the system were continuously fed the prepolymerized catalyst prepared above at a rate of 0.05 mmol/hr in terms of a zirconium atom and triisobutylaluminum at a rate of 10 mmol/hr. During the polymerization, ethylene, 1-hexene, hydrogen and nitrogen were continuously fed to maintain the gas composition constant (gas composition (volume ratio): 1-hexene/ethylene=0.034, hydrogen/ethylene=11.8×10⁻⁴, ethylene concentration=70%).

The properties of the ethylene/α-olefin copolymer (A-1) obtained are set forth in Table 1.

### Example 1

The ethylene/α-olefin copolymer (A-1) obtained in Preparation Example 1 was pelletized by an extruder, and the pellets were subjected to air-cooling inflation molding under the following molding conditions to prepare a film having a thickness of 30 μm and a width of 450 mm.

Molding Conditions

Molding machine: Placo LM inflation molding machine having a diameter of 65 mm (manufactured by Placo Co., specification for high-pressure low-density polyethylene resin)

Screw: L/D=28, C·R=2.8, equipped with intermediate mixing part

Die: 200 mm in diameter, 1.2 mm in lip width

Air ring: two-gap type

Molding temperature: 200° C.

Take-off rate: 18 m/min

The film obtained above was evaluated on the moldability, Young's modulus, tear strength (machine direction (sheet take-off direction)), dart impact strength, complete sealing temperature, hot tack properties and blocking strength.

The results are set forth in Table 2.

### Preparation Example 2

An ethylene/α-olefin copolymer (A-2) was prepared in the same manner as in Preparation Example 1, except that the polymerization was so conducted that the resulting copolymer had a density and MFR shown in Table 1. The properties of the ethylene/α-olefin copolymer (A-2) are set forth in Table 1.

### Example 2

A film was produced in the same manner as in Example 1, except that the ethylene/α-olefin copolymer (A-2) obtained in Preparation Example 2 was used. The film was evaluated in the same manner as in Example 1. The results are set forth in Table 2.

### Preparation Example 3

Ethylene/α-olefin copolymers (A-3) and (A-4) were each prepared in the same manner as in Preparation Example 1, except that the polymerization was so conducted that the resulting copolymer had a density and MFR shown in Table 1.

### Preparation of Composition (A-5)

The ethylene/α-olefin copolymers (A-3) and (A-4) obtained in Preparation Example 3 were melt kneaded in a weight ratio of 60/40 ((A-3)/(A-4)) to obtain an ethylene/α-olefin copolymer composition (A-5). The properties of the ethylene/α-olefin copolymer composition (A-5) are set forth in Table 1.

### Example 3

A film was produced in the same manner as in Example 1, except that the ethylene/α-olefin copolymer composition (A-5) obtained in Preparation Example 3 was used. The film was evaluated in the same manner as in Example 1. The results are set forth in Table 2.

### Preparation Example 4

An ethylene/α-olefin copolymer (A-6) was prepared in the same manner as in Preparation Example 1, except that, in the preparation of a catalyst, 13.4 liters of a toluene solution of bis(1,3-n-butylmethylmethylcyclopentadienyl)zirconium dichloride (Zr=34.0 mmol/l) and 4.0 liters of a toluene solution of bis(1,3-dimethylcyclopentadienyl)zirconium dichloride (Zr=28.4 mmol/l) were used in place of the toluene solution of bis(1,3-dimethylcyclopentadienyl)zirconium dichloride and the polymerization was so conducted that the resulting copolymer had a density and MFR shown in Table 1. The properties of the ethylene/α-olefin copolymer (A-6) are set forth in Table 1.

### Example 4

A film was produced in the same manner as in Example 1, except that the ethylene/α-olefin copolymer (A-6) obtained in Preparation Example 4 was used. The film was evaluated in the same manner as in Example 1. The results are set forth in Table 2.

### Preparation Example 5

An ethylene/α-olefin copolymer (A-7) was prepared in the same manner as in Preparation Example 1, except that a titanium catalyst component described in Japanese Patent Publication No. 54289/1988 was used in place of bis(1.3-dimethylcyclopentadienyl)zirconium dichloride, triethylaluminum was used in place of methylaluminoxane and the gas composition was adjusted. The properties of the ethylene/α-olefin copolymer (A-7) are set forth in Table 1.

### Comparative Example 1

A film was produced in the same manner as in Example 1, except that the ethylene/α-olefin copolymer (A-7) obtained in Preparation Example 5 was used. The film was evaluated in the same manner as in Example 1. The results are set forth in Table 2.

TABLE 1

| | Comonomer | | | | | n-decane | | | | | | | |
|---|---|---|---|---|---|---|---|---|---|---|---|---|---|
| | | Content | MFR | (η) | Density | soluble | | TM | MT | | | FI | |
| Copolymer | Type | mol % | g/10 min | dl/g | g/cm³ | part wt % | *1 | ° C. | g | *2 | *3 | S⁻¹ | *4 |
| A-1 | 1-hexene | 3.2 | 1.00 | 1.58 | 0.918 | 0.43 | 1.89 | 114.8 | 3.3 | 2.2 | 5.5 | 200 | 75 |
| A-2 | 1-hexene | 4.5 | 0.92 | 1.60 | 0.911 | 0.62 | 3.70 | 112.2 | 3.6 | 2.4 | 5.8 | 190 | 69 |
| A-3 | 1-hexene | 4.9 | 0.20 | 2.01 | 0.907 | 0.53 | 5.48 | 110.9 | 8.9 | 8.5 | 15.7 | 60 | 15 |
| A-4 | 1-hexene | 3.0 | 45.1 | 0.95 | 0.919 | 0.45 | — | 115.0 | — | — | — | 2350 | — |
| A-5 | — | — | 1.25 | — | 0.912 | 0.50 | 3.36 | — | 3.2 | 1.9 | 5.0 | 300 | 87 |
| A-6 | 1-hexene | 4.1 | 1.24 | 1.73 | 0.915 | 0.48 | 2.52 | 114.0 | 3.8 | 1.8 | 4.8 | 170 | 93 |
| A-7 | 1-hexene | 4.0 | 1.10 | 1.81 | 0.918 | 8.56 | 1.89 | 122.8 | 1.8 | 2.0 | 5.2 | 190 | 83 |

*1: Value of 80 × exp(−100(d − 0.88) + 0.1
*2: Value of 2.2 × MFR^{-0.84}
*3: Value of 5.5 × MPR^{-0.65}
*4: Value of 75 × MFR

TABLE 2

| | | | | | Tear | | | | | |
|---|---|---|---|---|---|---|---|---|---|---|
| | | | | Dart | strength | Complete | | | | |
| | | Mold- | Young's | impact | Machine | sealing | Blocking | Hot tack properties | | |
| | | ability | Modulus | strength | Direction | temperature | Strength | *6 mm | | |
| | Copolymer | *5 | kg/cm² | kg/cm | kg/cm | ° C. | g/cm | 100° C. *7 | 110° C. | 115° C. |
| Example | A-1 | ◯ | 3000 | 183 | 38 | 120 | 0.2 | 300 | 40 | 30 |
| 1 | | | | | | | | | | |
| Example | A-2 | ◯ | 2100 | 305 | 32 | 115 | 0.7 | 300 | 25 | 15 |
| 2 | | | | | | | | | | |
| Example | A-5 | ◯ | 2300 | 510 | 37 | 110 | 0.7 | 110 | 25 | 15 |
| 3 | | | | | | | | | | |
| Example | A-6 | ◯ | 2300 | 330 | 36 | 120 | 0.4 | 300 | 35 | 25 |
| 4 | | | | | | | | | | |
| Compar. | A-7 | X | 2800 | 95 | 90 | 130 | 1.9 | 300 | 80 | 50 |
| Exam. 1 | | | | | | | | | | |

*5: Moldability (Bubble stability) ◯: good X: bad
*6: Each value in the table indicates the distance peeled.
*7: Sealing temperature

What is claimed is:

1. An ethylene resin sealant for a laminated film, comprising an ethylene/α-olefin copolymer (A) which is a copolymer of ethylene and an α-olefin of 6 to 20 carbon atoms and has the following properties:
(i) the density is in the range of 0.880 to 0.920 g/cm³,
(ii) the melt flow rate (MFR (g/10 min)) at 190° C. under a load of 2.16 kg is in the range of 0.1 to 5.0 g/10 min,
(iii) the decane-soluble component fraction (W (% by weight)) at room temperature and the density (d (g/cm³)) satisfy the following relation
W<80×exp(−100(d−0.88))+0.1,
(iv) the flow index (FI (1/sec)), which is defined as a shear rate at which the shear stress of said copolymer in a molten state at 190° C. reaches 2.4×10⁶ dyne/cm², and the melt flow rate (MFR (g/10 min)) satisfy the following relation
FI>75×MFR, and
(v) the melt tension (MT (g)) at 190° C. and the melt flow rate (MFR (g/10 min)) satisfy the following relation 5.5×MFR^{-0.65}>MT>2.2×MFR^{-0.84}.

2. The ethylene resin sealant for a laminated film as claimed in claim 1, wherein the ethylene/α-olefin copolymer (A) is an ethylene/α-olefin copolymer obtained by copolymerizing ethylene and an α-olefin of 6 to 20 carbon atoms in the presence of an olefin polymerization catalyst comprising (a) an organoaluminum oxy-compound and (b) a compound of a transition metal of Group IV of the periodic table, said compound (b) containing a ligand having cyclopentadienyl skeleton.

3. An ethylene resin sealant for a laminated film, comprising an ethylene/α-olefin copolymer composition which comprises:
(I) 50 to 99 parts by weight of an ethylene/α-olefin random copolymer (A), and
(II) 1 to 50 parts by weight of an ethylene copolymer (B),
wherein the ethylene/α-olefin random copolymer (A) is a copolymer obtained by copolymerizing ethylene and an α-olefin of 6 to 20 carbon atoms in the presence of an olefin polymerization catalyst comprising (a) an organoaluminum oxy-compound and (b) a compound of a transition metal of Group IV of the periodic table, said compound (b) containing a ligand having cyclopentadienyl skeleton, and has the following properties:
(i) the density is in the range of 0.880 to 0.918 g/cm³,
(ii) the melt flow rate (MFR (g/10 min)) at 190° C. under a load of 2.16 kg is in the range of 0.03 to 1.0 g/10 min,
(iii) the temperature (Tm (° C.)) at the maximum peak position of an endothermic curve, as measured by a differential scanning calorimeter (DSC), and the density (d (g/cm³)) satisfy the following relation
Tm<400d−250,
(iv) the decane-soluble component fraction (W (% by weight)) at room temperature and the density (d (g/cm³)) satisfy the following relation
W<80×exp(−100(d−0.88))+0.1,
(v) the flow index (FI (1/sec)), which is defined as a shear rate at which the shear stress of said copolymer in a molten state at 190° C. reaches 2.4×10⁶ dyne/cm², and the melt flow rate (MFR (g/10 min)) satisfy the following relation
FI>75×MFR, and
(vi) the melt tension (MT (g)) at 190° C. and the melt flow rate (MFR (g/10 min)) satisfy the following relation
5.5×MFR^{-0.65}>MT>2.2×MFR^{-0.84};
and
the ethylene copolymer (B) is a copolymer obtained by copolymerizing ethylene and an α-olefin of 3 to 20 carbon atoms and has the following properties:
(i) the density is in the range of 0.890 to 0.935 g/cm³, and
(ii) the melt flow rate (MFR (g/10 min)) at 190° C. under a load of 2.16 kg is in the range of 0.1 to 100 g/10 min.

4. The ethylene resin sealant for a laminated film as claimed in any one of claims 1 to 3, which is a film produced by air-cooling inflation molding and having the following properties:
(i) the dart impact strength is not less than 100 kg/cm, and
(ii) the complete sealing temperature is not higher than 130° C.
